(19) United States
(12) Patent Application Publication
(10) Pub. No.: US 2014/0317324 A1
(43) Pub. Date: Oct. 23, 2014

(54) INTERRUPT CONTROL SYSTEM AND METHOD

(71) Applicants: HON HAI PRECISION INDUSTRY CO., LTD., New Taipei (TW); HONG FU JIN PRECISION INDUSTRY (ShenZhen) CO., LTD ., Shenzhen (CN)

(72) Inventor: MING YU, Shenzhen (CN)

(73) Assignees: HON HAI PRECISION INDUSTRY CO., LTD., New Taipei (TW); HONG FU JIN PRECISION INDUSTRY (ShenZhen) CO., LTD ., Shenzhen (CN)

(21) Appl. No.: 14/065,486

(22) Filed: Oct. 29, 2013

(30) Foreign Application Priority Data
Apr. 18, 2013 (CN) 201310134998X

(51) Int. Cl. G06F 13/24

(52) U.S. Cl. CPC G06F 13/24
USPC 710/260

(57) ABSTRACT

An interrupt control system includes a plurality of interrupt sources and a processor. Each interrupt source when activated includes a flag bit. The processor includes a parallel port with multiple pins and a decoding module. The different interrupt sources are connected to different pins of the parallel port. The parallel port thus receives different codes when different interrupt sources generate an interrupt. The decoding module decodes the code received by the parallel port to establish the interrupt source which has generated the interrupt.

### BACKGROUND

1. Technical Field

The present disclosure relates to control systems and control methods, and more particularly, to an interrupt control system and an interrupt control method.

2. Description of Related Art

In computer systems, an interrupt is a signal to the processor indicating an event that needs immediate attention. An interrupt alerts the processor to a high-priority condition requiring interruption of the current code the processor is executing. The processor responds by suspending its current activities, saving its state, and finding the interrupt source corresponding to the interrupt signal. Usually, the processor checks elements in the computer systems one by one to find out the interrupt source, which is time-consuming.

Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block diagram of one embodiment of an interrupt control system.

FIG. 2 is a flowchart of on embodiment of an interrupt control method.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

In general, the word “module,” as used herein, refers to logic embodied in hardware or firmware, or to a collection of software instructions, written in a programming language such as Java, C, or assembly. One or more software instructions in the modules may be embedded in firmware, such as in an erasable-programmable read-only memory (EPROM). The modules described herein may be implemented as either software and/or hardware modules and may be stored in any type of non-transitory computer-readable medium or other storage device. Some non-limiting examples of non-transitory computer-readable media are compact discs (CDs), digital versatile discs (DVDs), Blu-Ray discs, Flash memory, and hard disk drives.

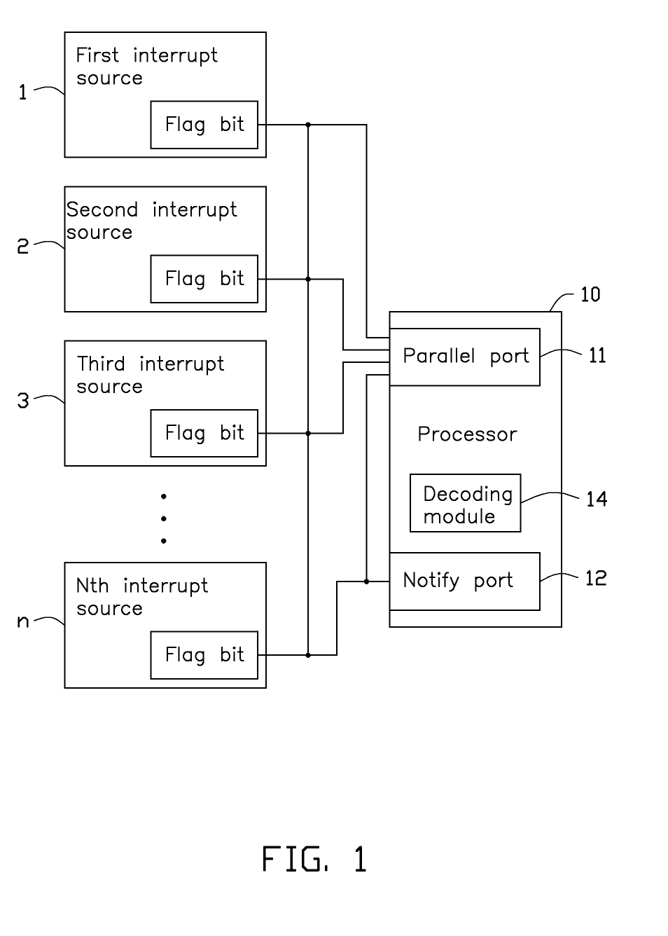

FIG. 1 shows one embodiment of an interrupt control system. The interrupt control system includes a processor 10 and a plurality of interrupt sources. In one embodiment, the plurality of interrupt sources includes a first interrupt source 1, a second interrupt source 2, a third interrupt source 3, and further to an Nth interrupt sources. The plurality of interrupt sources are different elements of a computer system, such as keyboards, mouse, touch pads, USB detecting module, and others. Each of the plurality of interrupt sources includes a flag bit. The flag bit is set to “1” in normal non-interrupt working situation, and the flag bit is changed from “1” to “0” when an interrupt is generated on the corresponding interrupt source.

The processor 10 includes a parallel port 11. The flag bits of the plurality of interrupt sources are connected to different pins of the parallel port 11. A number of pins of the parallel port 11 is not smaller than a number of the interrupt sources. For example, the flag bit of the first interrupt source 1 is connected to a first pin of the parallel port 11, the flag bit of the second interrupt source 2 is connected to a second pin of the parallel port 11, the flag bit of the third interrupt source 3 is connected to a third pin of the parallel port 11, and the rest likewise Therefore, when different interrupt source generates an interrupt, the parallel port 11 receives different codes. For example, when the first interrupt source 1 generates an interrupt and other interrupt sources do not generate interrupt, the parallel port 11 receives a code “011 . . . ”. When the second interrupt source 2 generates an interrupt and other interrupt sources do not generate an interrupt, the parallel port 11 receives a code “101 . . . ”. When the third interrupt source 3 generates an interrupt and other interrupt sources do not generate interrupt, the parallel port 11 receives a code “110 . . . ”. In another embodiment, pins of two or more parallel ports 11 can be used to connect the flag bits of the plurality of interrupt sources. Therefore, the code is formed by the particular activated pins of the two or more parallel ports.

The flag bits of the plurality of interrupt sources are connected to a notify port 12 of the processor 10 via a wired-and logic. Therefore, when any one of the plurality of interrupt sources outputs an interrupt, the notify port 12 receives a notice of interrupt. The processor 10 processes the interrupt. The processor 10 further includes a decoding module 14. The decoding module 14 decodes the code received by the parallel port 11. Therefore, the processor 10 instantly establishes the interrupt source which has outputted the interrupt based on the decoded code. For example, after the parallel port 11 receives a code “011 . . . ”, the decoding module 14 decodes the code and quickly finds out the first interrupt source 1. Therefore, the interrupt request of the first interrupt source 1 can be instantly processed.

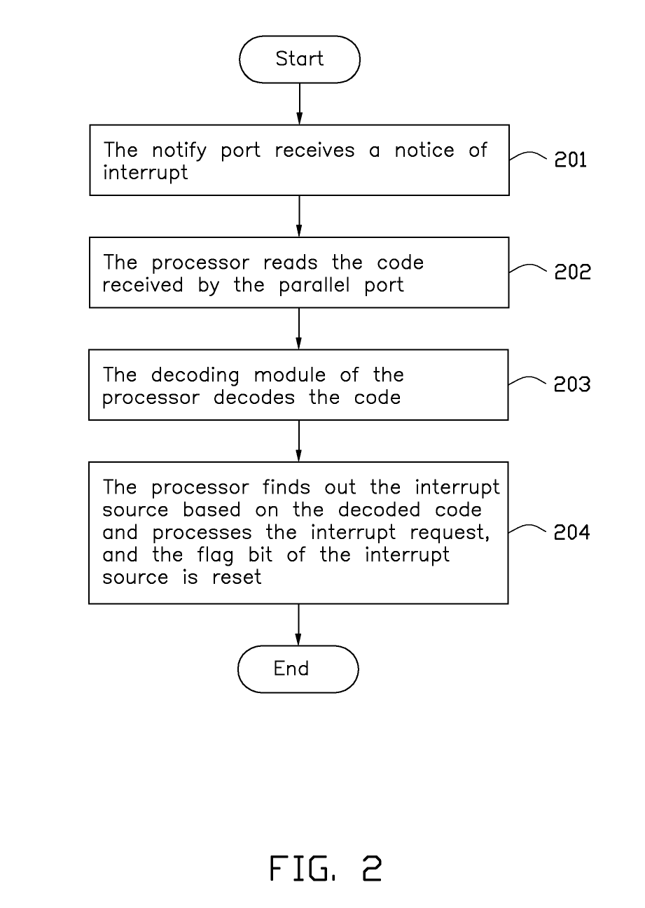

FIG. 2 is a flowchart showing one embodiment of a method for controlling interrupt. The method includes following steps:

In step 201, the notify port 12 receives a notice of interrupt.

In step 202, the processor 10 reads the code received by the parallel port 11.

In step 203, the decoding module 14 of the processor 10 decodes the code.

In step 204, the processor 10 finds out the interrupt source based on the decoded code and processes the interrupt request, and the flag bit of the interrupt source is reset.

Although numerous characteristics and advantages have been set forth in the foregoing description of embodiments, together with details of the structures and functions of the embodiments, the disclosure is illustrative only, and changes may be made in detail, especially in the matters of arrangement of parts within the principles of the disclosure to the full extent indicated by the broad general meaning of the terms in which the appended claims are expressed.

In particular, depending on the embodiment, certain steps or methods described may be removed, others may be added, and the sequence of steps may be altered. The description and the claims drawn for or in relation to a method may give some indication in reference to certain steps. However, any indication given is only to be viewed for identification purposes, and is not necessarily a suggestion as to an order for the steps.

What is claimed is:

1. An interrupt control system, comprising:
a plurality of interrupt sources, each of the plurality of interrupt sources comprising a flag bit; and
a processor comprising a parallel port and a decoding module, the parallel port comprising a plurality of pins, the flag bit of different interrupt source of the plurality of interrupt sources connected to different pin of the plurality of pins of the parallel port, the parallel port configured to receive different code when different one of the plurality of interrupt sources generates an interrupt, and the decoding module configured to decode the code received by the parallel port to find out the interrupt source, which generates the interrupt, from the plurality of interrupt sources.

2. The interrupt control system of claim 1, wherein the processor further comprises a notify port, and the flag bits of the plurality of interrupt sources are connected to the notify port via a wired-and logic.

3. The interrupt control system of claim 2, wherein the notify port is configured to receive a notice of interrupt when any of the plurality of interrupt sources outputs an interrupt.

4. The interrupt control system of claim 1, wherein a number of the plurality of pins of the parallel port is not smaller than a number of the plurality of interrupt sources.

5. The interrupt control system of claim 1, wherein the flag bit of each of the plurality of interrupt sources is set to “1” in normal non-interrupt working situation, and the flag bit is configured to be changed from “1” to “0” when an interrupt is generated on the corresponding interrupt sources.

6. An interrupt control method for controlling a plurality of interrupt sources, each of the plurality of interrupt sources comprising a flag bit, the method comprising:
connecting the flag bit of different interrupt source of the plurality of interrupt sources to different pin of a plurality of pins of a parallel port of a processor;
the parallel port receiving a code when anyone of the plurality of interrupt sources generates an interrupt;
a decoding module decoding the code received by the parallel port; and
the processor finding out the interrupt source, which generates the interrupt, from the plurality of interrupt sources based on the decoded code.

7. The interrupt control method of claim 6, further comprising connecting the flag bits of the plurality of interrupt sources to a notify port of the processor via a wired-and logic.

8. The interrupt control method of claim 7, wherein the notify port receive a notice of interrupt when anyone of the plurality of interrupt sources outputs an interrupt.

9. The interrupt control method of claim 6, wherein a number of the plurality of pins of the parallel port is not smaller than a number of the plurality of interrupt sources.

10. The interrupt control method of claim 6, wherein the flag bit of each of the plurality of interrupt sources is set to “1” in normal non-interrupt working situation , and the flag bit is configured to be changed from “1” to “0” when an interrupt is generated on the corresponding interrupt sources.
